(19) United States
(12) Patent Application Publication
(10) Pub. No.: US 2025/0342989 A1
(43) Pub. Date: Nov. 6, 2025

(54) OVER-CURRENT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW)

(21) Appl. No.: 18/656,310

(22) Filed: May 6, 2024

(51) Int. Cl. H01C 7/02

(52) U.S. Cl. CPC H01C 7/021

(57) ABSTRACT

An over-current protection device includes a first positive temperature coefficient (PTC) component, a second PTC component, a first insulation layer, and a first conductive via. The first PTC component includes a first PTC element, and a first electrode, a second electrode and a third electrode that are disposed on the first PTC element. The second PTC component includes a second PTC element, and a fourth electrode and a fifth electrode that are disposed on the second PTC element. The first insulation layer is disposed between the first PTC component and the second PTC component. The first conductive via electrically connects the first PTC component and the second PTC component.

### FIELD

The disclosure relates to an over-current protection device, and more particularly to an over-current protection device including two positive temperature coefficient (PTC) components, an insulation layer disposed between the two PTC components, and conductive vias.

### BACKGROUND

A positive temperature coefficient (PTC) device exhibits a PTC effect, which allows the PTC device to provide similar effect as that of an over-current protection device, such as a resettable fuse. The PTC device includes a PTC component, a first electrode and a second electrode which are respectively disposed on two opposite surfaces of the PTC component.

The PTC component includes a polymer matrix which includes a crystalline region and a non-crystalline region. The PTC component also includes a particulate conductive filler which is dispersed throughout the non-crystalline region of the polymer matrix and which is formed into a continuous conductive path for electrical conduction between the first and second electrodes. When the polymer matrix reaches its melting point, crystals within the crystalline region of the polymer matrix start melting to form a new non-crystalline region, which is known as the PTC effect. When the new non-crystalline region becomes larger and merges with the original non-crystalline region, the conductive path becomes discontinuous and resistance of the polymer matrix significantly increases, which results in electrical disconnection between the first and second electrodes.

FIGS. 1A and 1B illustrate a conventional PTC device that includes a PTC component 91, a first electrode 92, and a second electrode 93. The conventional PTC device still has room for improvement.

### SUMMARY

Therefore, an object of the disclosure is to provide an over-current protection device that can alleviate at least one of the drawbacks of the prior art.

According to the present disclosure, an over-current protection device includes a first positive temperature coefficient (PTC) component, a second PTC component, a first insulation layer, and a first conductive via.

The first PTC component includes a first PTC element, and a first electrode, a second electrode and a third electrode that are disposed on the first PTC element.

The second PTC component includes a second PTC element, and a fourth electrode and a fifth electrode that are disposed on the second PTC element.

The first insulation layer is disposed between the first PTC component and the second PTC component.

The first conductive via electrically connects the first PTC component and the second PTC component.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIGS. 1A and 1B are schematic views illustrating a conventional positive temperature coefficient (PTC) device.

FIG. 2 is a schematic view illustrating a first embodiment of an over-current protection device according to the present disclosure.

FIG. 3 is a schematic view illustrating a second embodiment of the over-current protection device according to the present disclosure.

FIG. 4 is a circuit diagram illustrating examples of the over-current protection device subjecting to a hold current test and a trip current test.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “upper,” “lower,” “on,” “over,” and the like may be used throughout the disclosure while making reference to the features as illustrated in the drawings. The features may be oriented differently (e.g., rotated 90 degrees or at other orientations) and the spatially relative terms used herein may be interpreted accordingly.

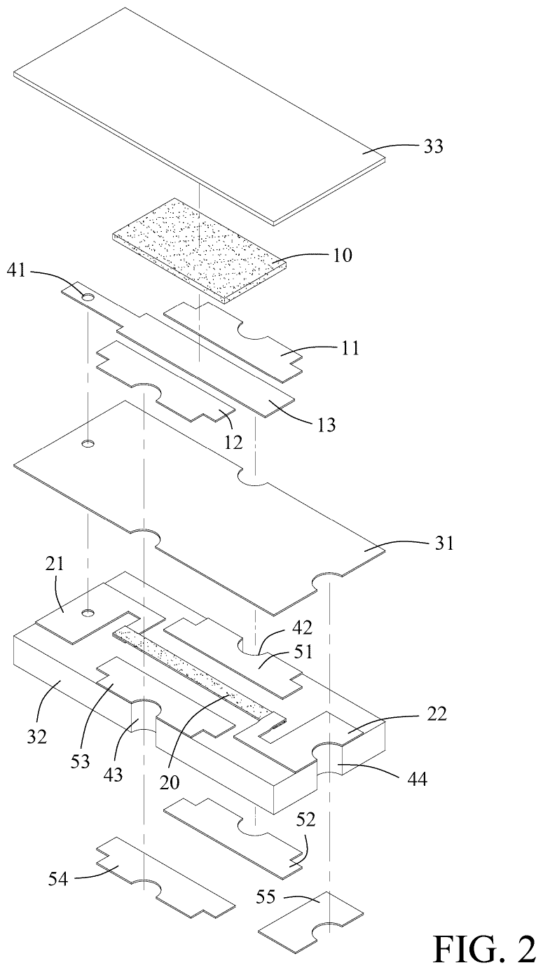

Referring to FIG. 2, a first embodiment of an over-current protection device according to the present disclosure includes a first positive temperature coefficient (PTC) component, a second PTC component, a first insulation layer 31, and a first conductive via 41.

The first PTC component includes a first PTC element 10, and a first electrode 11, a second electrode 12 and a third electrode 13 that are disposed on the first PTC element 10. In certain embodiments, the first electrode 11, the second electrode 12, and the third electrode 13 are spacedly disposed on a surface of the first PTC element 10. In certain embodiments, the third electrode 13 is disposed between the first electrode 11 and the second electrode 12. The first PTC element 10 may be a polymeric PTC layer that includes a polymer matrix and a conductive filler dispersed in the polymer matrix. The polymer matrix may be made from a polymer composition that contains a non-grafted olefin-based polymer. In certain embodiments, the non-grafted olefin-based polymer is high density polyethylene (HDPE). In other embodiments, the polymer composition further includes a carboxylic anhydride-grafted olefin-based polymer. The conductive filler may include, but are not limited to, carbon black, metal, electrically conductive ceramic, and combinations thereof. Each of the first electrode 11 and the second electrode 12 is made of a conductive material, such as metal (e.g., nickel, copper (e.g., copper foil sheet), etc.)

The second PTC component includes a second PTC element 20, and a fourth electrode 21 and a fifth electrode 22 that are disposed on the second PTC element 20. In certain embodiments, the fourth electrode 21 is disposed on and extends outwardly from a lower surface of the second PTC element 20, and the fifth electrode 22 is disposed on and extends outwardly from an upper surface of the second PTC element 20. The second PTC element 20 may be made of a material the same as that of the first PTC element 10. Each of the fourth electrode 21 and the fifth electrode 22 may be made of a conductive material, such as metal (e.g., nickel, copper (e.g., copper foil sheet), etc.)

In certain embodiments, the over-current protection device further includes a second insulation layer 32, and the second PTC element 20, the fourth electrode 21 and the fifth electrode 22 of the second PTC component may be disposed on a first surface (e.g., an upper surface) of the second insulation layer 32.

The first insulation layer 31 is disposed between the first PTC component and the second PTC component. The second insulation layer 32 is disposed on the second PTC component opposite to the first insulation layer 31.

In certain embodiments, the over-current protection device may further include a third insulation layer 33 which may be disposed on the first PTC component opposite to the first insulation layer 31. In certain embodiments, each of the first insulation layer 31, the second insulation layer 32, and the third insulation layer 33 is made of epoxy glass fiber.

The first conductive via 41 electrically connects the first PTC component and the second PTC component. In this embodiment, the first conductive via 41 electrically connects the third electrode 13 of the first PTC component and the fourth electrode 21 of the second PTC component. In certain embodiments, the first conductive via 41 extends through the third electrode 13 of the first PTC component, the first insulation layer 31, and the fourth electrode 21 of the second PTC component.

In certain embodiments, the over-current protection device further includes a first conductive element 51, a second conductive element 52 and a second conductive via 42. The first conductive element 51 and the second conductive element 52 may be respectively disposed on the first surface (e.g., the upper surface) and a second surface (e.g., a lower surface) of the second insulation layer 32, where the first surface and the second surface of the second insulation layer 32 are opposite to each other.

The second conductive via 42 is spaced apart from the first conductive via 41, and electrically connects the first electrode 11 of the first PTC component, the first conductive element 51 and the second conductive element 52. In certain embodiments, the second conductive via 42 extends through the first electrode 11 of the first PTC component, the first insulation layer 31, the first conductive element 51, the second insulation layer 32, and the second conductive element 52, so as to electrically connect the first electrode 11, the first conductive element 51 and the second conductive element 52.

In certain embodiments, the over-current protection device further includes a third conductive element 53, a fourth conductive element 54 and a third conductive via 43. The third conductive element 53 and the fourth conductive element 54 may be respectively disposed on the first surface (e.g., the upper surface) and the second surface (e.g., the lower surface) of the second insulation layer 32.

The third conductive via 43 is spaced apart from the first conductive via 41 and the second conductive via 42, and electrically connects the second electrode 12 of the first PTC component, the third conductive element 53 and the fourth conductive element 54. In certain embodiments, the third conductive via 43 extends through the second electrode 12 of the first PTC component, the first insulation layer 31, the third conductive element 53, the second insulation layer 32, and the fourth conductive element 54, so as to electrically connect the second electrode 12, the third conductive element 53 and the fourth conductive element 54.

In certain embodiments, the first conductive element 51 and the third conductive element 53 are separated from each other by the second PTC element 20 of the second PTC component.

In certain embodiments, the over-current protection device further includes a fourth conductive via 44 and a fifth conductive element 55 that is disposed on the second surface of the second insulation layer 32.

The fourth conductive via 44 is spaced apart from the first conductive via 41, the second conductive via 42 and the third conductive via 43, and electrically connects the fifth electrode 22 of the second PTC component and the fifth conductive element 55. In certain embodiments, the fourth conductive via 44 extends through the fifth electrode 22 of the second PTC component, the second insulation layer 32, and the fifth conductive element 55, so as to electrically connect the fifth electrode 22 and the fifth conductive element 55.

In certain embodiments, each of the first conductive via 41, the second conductive via 42, the third conductive via 43, and the fourth conductive via 44 is made of a conductive material, such as silver or copper.

In certain embodiments, the second conductive via 42, the third conductive via 43, and the fourth conductive via 44 are formed to be indented from a periphery of the over-current protection device. To be specific, each of the first electrode 11, the second electrode 12, the fifth electrode 22, the first conductive element 51, the second conductive element 52, the third conductive element 53, the fourth conductive element 54, and the fifth conductive element 55 is formed with a recess indented from a periphery thereof. The first insulation layer 31 is formed with three recesses indented from a periphery thereof, and a first one of the recesses of the first insulation layer 31 corresponds in position to the recesses of the first electrode 11 and the first conductive element 51, a second one of the recesses of the first insulation layer 31 corresponds in position to the recesses of the second electrode 12 and the third conductive element 53, and a third one of the recesses of the first insulation layer 31 corresponds in position to the recess of the fifth electrode 22. In this embodiment, the three recesses of the first insulation layer 31 are respectively located at three sides of the periphery of the first insulation layer 31.

The second insulation layer 32 is formed with three recesses indented from a periphery thereof, and a first one of the recesses of the second insulation layer 32 corresponds in position to the recesses of the first conductive element 51 and the second conductive element 52, a second one of the recesses of the second insulation layer 32 corresponds in position to the recesses of the third conductive element 53 and the fourth conductive element 54, and a third one of the recesses of the second insulation layer 32 corresponds in position to the recesses of the fifth electrode 22 and the fifth conductive element 55. In this embodiment, the three recesses of the second insulation layer 32 are respectively located at three sides of the periphery of the second insulation layer 32. In certain embodiments, conductive materials are formed in the recesses of the first electrode 11, the second electrode 12, the fifth electrode 22, the first insulation layer 31, the second insulation layer 32, the first conductive element 51, the second conductive element 52, the third conductive element 53, the fourth conductive element 54, and the fifth conductive element 55, so as to form the second conductive via 42, the third conductive via 43 and the fourth conductive via 44.

In certain embodiments, the second conductive element 52, the fourth conductive element 54, and the fifth conductive element 55 are disposed on the second surface (e.g., the lower surface) of the second insulation layer 32.

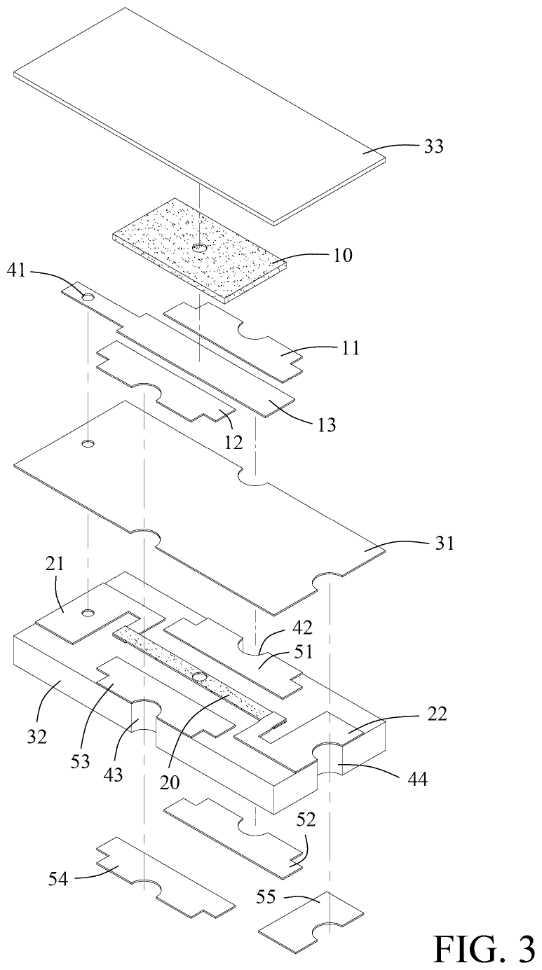

Referring to FIG. 3, a second embodiment of the over-current protection device according to the present disclosure is generally similar to the first embodiment, except that in the second embodiment, the first PTC component is formed with at least one hole that is formed in the first PTC element 10, and the second PTC component is formed with at least one hole that is formed in the second PTC element 20. In certain embodiments, the at least one hole formed in the first PTC element 10 may penetrate the same, and the at least one hole formed in the second PTC element 20 may penetrate the same. In certain embodiments, the at least one hole formed in the first PTC element 10 may penetrate the first PTC element 10 and one of the first electrode 11 and the second electrode 12. In other embodiments, the at least one hole formed in the first PTC element 10 may penetrate the first PTC element 10 and extend into the one of the first electrode 11 and the second electrode 12. In certain embodiments, only one of the first PTC component and the second PTC component is formed with the at least one hole.

The over-current protection device according to the disclosure may be connected to a circuit structure of an electrical device, and may provide two electrical conduction paths.

For the first electrical conduction path, an electric current flows through the second conductive via 42 and the first PTC component to the third conductive via 43.

For the second electrical conduction path, an electric current flows through the second conductive via 42 (or the third conductive via 43), the first PTC component, and the second PTC component to the fourth conductive via 44.

With the provision of the over-current protection device provided with the two electrical conduction paths, the circuit structure of the electrical device may be efficiently prevented from being damaged under over-current condition.

Examples and a comparative example of the disclosure will be described hereinafter. It is to be understood that these examples and the comparative example are exemplary and explanatory and should not be construed as a limitation to the disclosure.

### EXAMPLES

### Example 1 (E1)

An over-current protection device of E1 having the structure shown in FIG. 2 was prepared. Firstly, 10.25 grams of high density polyethylene (HDPE, purchased from Formosa Plastics Corp., catalog no.: HDPE9002, and serving as a non-grafted olefin-based polymer), 10.25 grams of maleic anhydride-grafted HDPE (purchased from Dupont, catalog no.: MB100D, and serving as a carboxylic acid anhydride-grafted olefin-based polymer), and 29.5 grams of carbon black powder (purchased from Columbian Chemicals Co., catalog no.: Raven 430UB, and serving as a conductive filler) were compounded in a Brabender mixer at a temperature of 200° C. and at a stirring rate of 30 rpm for 10 minutes, so as to obtain a first compounded mixture. The first compounded mixture was hot pressed in a mold at 200° C. under 80 kg/cm² for 4 minutes, so as to obtain a thin sheet of a first PTC layer. The first PTC layer was irradiated with a Cobalt-60 gamma ray for a total irradiation dose of 150 kGy. The first PTC layer was then cut into first PTC elements each having with a length of 4.5 mm, a width of 3.2 mm, and a thickness of 0.35 mm.

12.5 grams of HDPE, 12.5 grams of maleic anhydride-grafted HDPE, and 25 grams of carbon black powder were compounded in a Brabender mixer at a temperature of 200° C. and at a stirring rate of 30 rpm for 10 minutes, so as to obtain a second compounded mixture. The second compounded mixture was hot pressed in a mold at 200° C. under 80 kg/cm² for 4 minutes, so as to form a thin sheet of a second PTC layer. The second PTC layer was irradiated with a Cobalt-60 gamma ray for a total irradiation dose of 150 kGy. The second PTC layer was then cut into second PTC elements each having a length of 3.0 mm, a width of 0.5 mm, and a thickness of 0.35 mm.

First, second and third insulation layers were provided. Each of the first, second and third insulation layers is made of epoxy resin.

First to three electrodes were formed on a first surface of the first insulation layer, and a fifth electrode was formed on a second surface of the first insulation layer. The first surface and the second surface of the first insulation layer are opposite to each other. Each of the first to three electrodes and the fifth electrode were formed through a manufacturing process of printed circuit board (PCB). Each of the first to three electrodes and the fifth electrode was made of a conductive material, such as tin.

A fourth electrode, a first conductive element, a third conductive element were formed on a first surface of the second insulation layer, and a second conductive element, a fourth conductive element and a fifth conductive element were formed on a second surface of the second insulation layer. The first surface and the second surface of the second insulation layer are opposite to each other. Each of the fourth electrode and the first to fifth conductive elements were formed through a manufacturing process of PCB. The fourth electrode was made of a conductive material, such as tin. Each of the first conductive element, the second conductive element, the third conductive element, the fourth conductive element, and the fifth conductive element was made of a conductive material, such as copper.

The first PTC element, the second PTC element, the first insulation layer with the first electrode, the second electrode, the third electrode and the fifth electrode, and the second insulation layer with the fourth electrode and the first to fifth conductive elements, were hot pressed at 150° C. under 80 kg/cm² for 40 minutes, so as to form a PTC laminate having a size of 4.5 mm×3.2 mm. The PTC laminate includes a first PTC component and a second PTC component. The first PTC component includes the first PTC element, the first electrode, the second electrode, and the third electrode. The second PTC component includes the second PTC element, the fourth electrode, and the fifth electrode.

The PTC laminate was subjected to a drilling process and an electroplating process so as to form first, second, third and fourth conductive vias. The first conductive via electrically connects the third electrode and the fourth electrode so as to electrically connect the first PTC component and the second component. The second conductive via electrically connects the first electrode, the first conductive element and the second conductive element. The third conductive via electrically connects the second electrode, the third conductive element and the fourth conductive element. The fourth conductive via electrically connects the fifth electrode and the fifth conductive element. Afterwards, the third insulation layer was hot pressed and attached to the PTC laminate, so as to form an over-current protection device of E1 having the structure shown in FIG. 2.

### Example 2 (E2)

The over-current protection device of E2 has a structure shown in FIG. 3, and was prepared by procedures and conditions generally similar to those of E1, except that, each of the first PTC element and the second PTC element was formed with a hole.

### Comparative Example 1 (CE1)

10.25 grams of HDPE, 10.25 grams of maleic anhydride grafted HDPE, and 29.5 grams of carbon black were compounded in a Brabender mixer at a temperature of 200° C. and at a stirring rate of 30 rpm for 10 minutes.

The resultant compounded mixture was hot pressed in a mold at 200° C. under 80 kg/cm² for 4 minutes, so as to form a thin sheet of a PTC layer (serving as a PTC element) having a thickness of 0.35 mm.

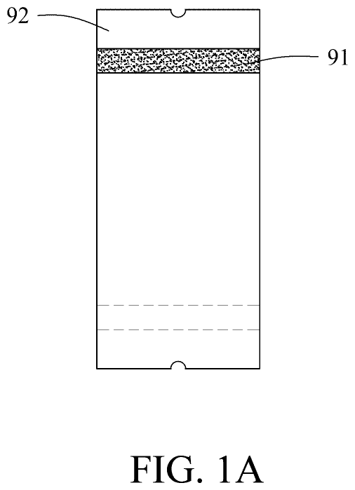

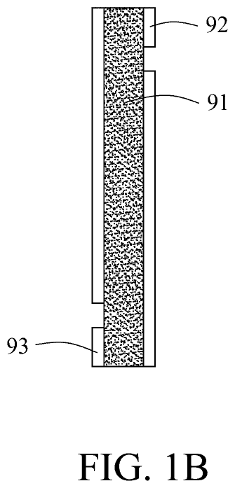

Two tin foil sheets were attached to two opposite sides of the thin sheet of the PTC layer, and were hot pressed at 200° C. under 80 kg/cm² for 4 minutes to form a sandwiched structure of a PTC laminate having a thickness of 0.42 mm. The PTC laminate was then cut into a plurality of PTC components, each of which having a size of 4.5 mm×3.2 mm. Each of the PTC components was irradiated with a Cobalt-60 gamma ray for a total irradiation dose of 150 kGy. Afterwards, each of the PTC components was sequentially subjected to a drilling process and an electroplating process (forming first and second electrodes), so as to form an over-current protection device of CE1 having a structure shown in FIGS. 1A and 1B.

### Performance Test

### Resistance Test

Ten test samples of each of E1, E2 and CE1, were subjected to a resistance test conducted according to the Underwriter Laboratories UL 1434 Standard for Safety for Thermistor-Type Devices using an ohmmeter, so as to determine the average initial resistance (Rᵢ) of the test samples. The average initial resistance (Rᵢ) of the test samples are shown in Table 1.

TABLE 1

| | | Resistance (Rᵢ, ohm) | |
|---|---|---|---|
| Test | | The first PTC | The second PTC |
| sample | Structure | component | component |
| E1 | FIG. 2 | 0.046 | 8.565 |
| E2 | FIG. 3 | 0.044 | 8.425 |
| CE1 | FIGS. 1A and 1B | 0.065 | NA |

### Hold Current Test

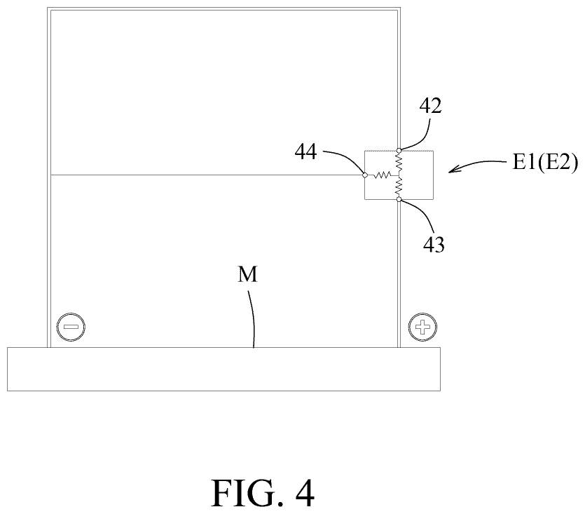

Ten test samples of each of E1, E2 and CE1 were subjected to a hold current test under a voltage of 16 V_{dc} for 15 minutes without causing it to trip under 25° C. to determine the hold currents of the test samples. FIG. 4 illustrates a circuit diagram of the test sample connected to a testing machine for hold current test and trip current test (which will be described hereinafter). As shown in FIG. 4, in order to determine the hold currents (trip currents) of the first PTC component and the second PTC component of each of the test samples of E1 and E2, the second conductive via (denoted by reference numeral 42), the third conductive via (denoted by reference numeral 43) were electrically and respectively connected to positive and negative electrodes of the testing machine (denoted by reference numeral M) so as to form a first loop, the third conductive via 43 and the fourth conductive via (denoted by reference numeral 44) were electrically and respectively connected to positive and negative electrodes of the testing machine M so as to form a second loop, and the first loop is connected in parallel with the second loop. The average values of the hold currents of the test samples of E1, E2 and CE1 are shown in Table 2. The results in Table 2 show that the hold current of E1 is 2.00 A, and the hold current of E2 is 2.10 A, which are significantly higher than that of CE1.

TABLE 2

| Electrical property | |
|---|---|
| The first | The second |
| PTC component | PTC component |

| | Hold | Trip | Hold | Trip |
|---|---|---|---|---|
| Test | current | current | current | current |
| sample | (A) | (A) | (A) | (A) |
| E1 | 2.00 | 2.80 | 0.01 | 0.016 |
| E2 | 2.10 | 2.60 | 0.012 | 0.015 |
| CE1 | 1.60 | 3.20 | NA | NA |

### Trip Current Test

Ten test samples of each of E1, E2 and CE1 were subjected to a trip current test under a voltage of 16 V_{dc} to determine the trip currents of the test samples. The test sample was deemed to pass the test if the trip time was over 20 seconds (within 20-30 seconds in this test). The average value of the trip currents of the passed test samples is shown in Table 2. The results in Table 2 show that the trip currents (the first PTC component) of E1 (2.80 A) and E2 (2.60 A) are significantly lower than that of CE1 (3.20 A), which indicates the structure of the over-current protection device according to the disclosure can be efficiently prevented from being damaged at an over-current condition.

### Switching Cycle Test

Ten test samples of each of E1, E2 and CE1 were subjected to a switching cycle test to determine variation of the resistances of the test samples. The switching cycle test was conducted under a voltage of 16 V_{dc} and a current of 100 A by switching on for 60 seconds and then off for 60 seconds per cycle for 6000 cycles according to the Underwriter Laboratories UL 1434 Standard for Thermistor-Type Devices. The resistance (R_{f}) of each of the test samples after (R_{f}) the 6000 cycles was measured. A percentage of average resistance variation (R_{f}/Rᵢ×100%) of the test samples of each of E1, E2 and CE1 was calculated (the resistance (Rᵢ) was shown in Table 1). The results of the switching cycle test are shown in Table 3.

TABLE 3

| | 16 V_{dc} / 100 A | | 16 V_{dc} / 100 A | |
|---|---|---|---|---|
| Test | 6000 test cycles | | 1000 test hours | |
| sample | Rf (ohm) | Rf/Ri × 100% | Rf (ohm) | Rf/Ri × 100% |
| | The first PTC component | | | |
| E1 | 0.462 | 1004% | 0.244 | 530% |
| E2 | 0.355 | 807% | 0.192 | 436% |
| CE1 | 1.958 | 3012% | 1.058 | 1628% |
| | The second PTC component | | | |
| E1 | 98.355 | 1148% | 49.875 | 582% |
| E2 | 82.456 | 979% | 41.212 | 489% |
| CE1 | NA | NA | NA | NA |

The results in Table 3 show that an average resistance variation (the first PTC component) of the test samples of each of E1 and E2 (i.e., ranging from 807% to 1004%) is lower than that of the test samples of CE1 (i.e., 3012%), which indicates that the structure of the over-current protection device according to the disclosure has a better thermal conductivity and exhibits better reliability.

### Aging Test

Ten test samples of each of E1, E2 and CE1 were subjected to an aging test to determine variation of the resistances of the test samples. The aging test was conducted by applying a voltage of 16 V_{dc} and a current of 100 A to each of the test samples for 1000 hours using a power supply (e.g., purchased from IDRC; Model: DSP-060-050), according to the Underwriter Laboratories UL 1434 Standard for Thermistor-Type Devices. The resistance (R_{f}) of each of the test samples after the 1000 hours were measured. A percentage of average resistance variation (R_{f}/Rᵢ×100%) of the test samples of each of E1, E2 and CE1 was calculated (the resistance Rᵢ was shown in Table 1). The results of the aging test are shown in Table 3.

The results in Table 3 show that an average resistance variation rate (the first PTC component) of the test samples of each of E1 and E2 (i.e., ranging from 436% to 530%) is lower than that of the test samples of CE1 (i.e., 1628%), which indicates that the structure of the over-current protection device according to the disclosure has a better thermal conductivity and exhibits better reliability.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An over-current protection device, comprising:
a first positive temperature coefficient (PTC) component that includes a first PTC element, and a first electrode, a second electrode and a third electrode that are disposed on said first PTC element;
a second PTC component that includes a second PTC element, and a fourth electrode and a fifth electrode that are disposed on said second PTC element;
a first insulation layer that is disposed between said first PTC component and said second PTC component; and
a first conductive via that electrically connects said first PTC component and said second PTC component.

2. The over-current protection device as claimed in claim 1, wherein said first electrode, said second electrode, and said third electrode are spacedly disposed on a surface of said first PTC element.

3. The over-current protection device as claimed in claim 2, wherein said third electrode is disposed between said first electrode and said second electrode, and said first conductive via electrically connects said third electrode and said fourth electrode.

4. The over-current protection device as claimed in claim 3, wherein said first conductive via extends through said third electrode, said first insulation layer and said fourth electrode.

5. The over-current protection device as claimed in claim 1, further comprising a second insulation layer disposed on said second PTC component opposite to said first insulation layer.

6. The over-current protection device as claimed in claim 5, wherein said second PTC element, said fourth electrode and said fifth electrode of said second PTC component are disposed on a surface of said second insulation layer.

7. The over-current protection device as claimed in claim 5, further comprising:
a first conductive element and a second conductive element that are respectively disposed on a first surface and a second surface of said second insulation layer, said first surface and said second surface being opposite to each other, and
a second conductive via that is spaced apart from said first conductive via and that electrically connects said first electrode of said first PTC component, said first conductive element and said second conductive element.

8. The over-current protection device as claimed in claim 7, wherein said second conductive via extends through said first electrode of said first PTC component, said first insulation layer, said first conductive element, said second insulation layer, and said second conductive element.

9. The over-current protection device as claimed in claim 8, further comprising:
a third conductive element and a fourth conductive element that are respectively disposed on said first surface and said second surface of said second insulation layer, and
a third conductive via that is spaced apart from said first conductive via and said second conductive via and that electrically connects said second electrode of said first PTC component, said third conductive element and said fourth conductive element.

10. The over-current protection device as claimed in claim 9, wherein said third conductive via extends through said second electrode of said first PTC component, said first insulation layer, said third conductive element, said second insulation layer, and said fourth conductive element.

11. The over-current protection device as claimed in claim 9, wherein said first conductive element and said third conductive element are separated from each other by said second PTC element of said second PTC component.

12. The over-current protection device as claimed in claim 9, further comprising:
a fifth conductive element that is disposed on said second insulation layer, and
a fourth conductive via that is spaced apart from said first conductive via, said second conductive via and said third conductive via, and that electrically connects said fifth electrode of said second PTC component and said fifth conductive element.

13. The over-current protection device as claimed in claim 12, wherein said fourth conductive via extends through said fifth electrode of said second PTC component, said second insulation layer, and said fifth conductive element.

14. The over-current protection device as claimed in claim 13, wherein said second conductive via, said third conductive via, and said fourth conductive via are formed to be indented from a periphery of said over-current protection device.

15. The over-current protection device as claimed in claim 13, wherein said fifth conductive element, said second conductive element, and said fourth conductive element are disposed on said second surface of said second insulation layer.

16. The over-current protection device as claimed in claim 5, further comprising a third insulation layer that is disposed on said first PTC component opposite to said first insulation layer.

17. The over-current protection device as claimed in claim 16, wherein each of said first insulation layer, said second insulation layer, and said third insulation layer is made of epoxy glass fiber.

18. The over-current protection device as claimed in claim 1, wherein said fourth electrode is disposed on and extends outwardly from a lower surface of said second PTC element, and said fifth electrode is disposed on and extends outwardly from an upper surface of said second PTC element.

19. The over-current protection device as claimed in claim 1, wherein said first PTC component is formed with at least one hole in said first PTC element.

20. The over-current protection device as claimed in claim 19, wherein said second PTC component is formed with at least one hole in said second PTC element.
